(19) United States
(12) Patent Application Publication
(10) Pub. No.: US 2024/0283930 A1
(43) Pub. Date: Aug. 22, 2024

(54) SYSTEMS AND METHODS FOR VIDEO ENCODING USING IMAGE SEGMENTATION

(71) Applicant: OP Solutions, LLC, Amherst, MA (US)

(72) Inventors: Hari Kalva, BOCA RATON, FL (US); Borivoje Furht, BOCA RATON, FL (US); Velibor Adzic, CANTON, GA (US)

(73) Assignee: OP Solutions, LLC, Amherst, MA (US)

(21) Appl. No.: 18/652,898

(22) Filed: May 2, 2024

Related U.S. Application Data
(63) Continuation of application No. PCT/US22/48822, filed on Nov. 3, 2022.
(60) Provisional application No. 63/275,677, filed on Nov. 4, 2021.

(51) Int. Cl. H04N 19/119; G06V 10/82; G06V 20/40; H04N 19/167; H04N 19/172; H04N 19/96

(52) U.S. Cl. CPC H04N 19/119; G06V 20/49; H04N 19/167; H04N 19/172; H04N 19/96; G06V 10/82

(57) ABSTRACT

A video encoder is provided that includes an image detection and segmentation processor receiving the video frame and generating object recognition data and at least one image segmentation mask. A mask to coding block mapping processor maps the segmentation mask to the CTUs of the video frame and partitions at least one CTU into a plurality of coding units (CUs) based on a detected object boundary in the CTU. A video encoding processor receives the video frame, the object recognition data and the partitioned CUs and encodes the CUs with at least one of a resolution or quantization parameter determined at least in part on whether the CU includes an object.

### CROSS-REFERENCE TO RELATED APPLICATIONS

The present application is a continuation of International Application PCT/US2022/048822 filed on Nov. 3, 2022, and entitled SYSTEMS AND METHODS FOR VIDEO ENCODING USING IMAGE SEGMENTATION, which claims the benefit of priority to U.S. Provisional Application Ser. No. 63/275,677 filed on Nov. 4, 2021, and entitled Systems and Methods for Video Encoder Acceleration Using Image Segmentation, the disclosure of which is hereby incorporated by reference in its entirety.

### FIELD OF THE INVENTION

The present disclosure generally relates to the field of video encoding and decoding. In particular, the present disclosure is directed to systems and methods for video encoder acceleration using image segmentation.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

### SUMMARY OF THE DISCLOSURE

A method of encoding a video signal and/or accelerating the encoding of a video signal includes receiving a video frame comprising a plurality of pixels and partitioning the video frame into a plurality of coding tree units (CTUs). Object detection and image segmentation is performed on the video frame to generate object recognition data and at least one segmentation mask identifying object boundaries. The segmentation mask is overlayed with the plurality of CTUs, and for a CTU in which an object boundary is identified, partition the CTU into at least two coding units (CUs) in which at least one CU contains the object of interest and at least one CU does not contain an object of interest.

Encoding of the video frame may include encoding of the CUs with a resolution and/or quantization parameter determined at least in part on whether the CU contains an object of interest.

The partition is preferably selected from the group including a horizontal partition, a vertical partition, and a geometric partition. Image segmentation can be selected from various known image segmentation methods, including semantic segmentation, instance segmentation, and panoptic segmentation.

The object recognition data includes instance labels for each object detected in the video frame. The object recognition data may include instance labels for each of the pixels in the video frame. The object recognition data can include object class, object position in the frame, and/or size information such as a bounding box of an object.

The method can further include performing motion estimation that is performed at least in part based on the object recognition data.

A video encoder is also provided herein. The video encoder receiving video frame data comprising a plurality of pixels and being partitionable into a plurality of coding tree units (CTU). The encoder includes an image detection and segmentation processor receiving the video frame and generating object recognition data and at least one image segmentation mask. A mask to coding block mapping processor is also provided for mapping the segmentation mask to the CTUs of the video frame and partitioning at least one CTU into a plurality of coding units (CUs) based on a detected object boundary in the CTU. A video encoding processor receives the video frame, the object recognition data and the partitioned CUs and encodes the CUs with at least one of a resolution or quantization parameter determined at least in part on whether the CU includes an object.

The mask to coding block mapping processor preferably partitions a CTU using a partition selected from the group including a horizontal partition, a vertical partition and a geometric partition.

The image detection and segmentation processor preferably applies an image segmentation method selected from the group including semantic segmentation, instance segmentation, and panoptic segmentation.

In some embodiments, the object recognition data can include instance labels for each object detected in the video frame. The object recognition data may include instance labels for each of the pixels in the video frame. The object recognition data may additionally or alternatively include object class, object position in the frame, and/or object size or bounding box information of an object.

The encoder may further include motion estimation processing, wherein motion estimation is performed at least in part based on the object recognition data.

The encoder may employ hardware acceleration. The image detection and segmentation processor may include or comprise a neural network.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram illustrating an exemplary embodiment of multi-type tree splitting modes;

FIG. 2 is a schematic diagram illustrating an exemplary embodiment of semantic segmentation;

FIG. 3 is a schematic diagram illustrating an exemplary embodiment of instance segmentation;

FIG. 4 is a schematic diagram illustrating an exemplary embodiment of panoptic segmentation;

FIG. 5 is a schematic diagram illustrating an exemplary embodiment of CTU boundaries with examples of CU partitioning, including horizontal partitioning (FIG. 5A) geometric partitioning (FIG. 5B), and an example of partitioning of two CTUs using a segmentation mask (FIG. 5C);

FIG. 6 is a schematic diagram illustrating an exemplary embodiment of segmentation mask to coding block structure mapping with CU and CTU boundaries and geometric partitioning;

FIG. 7 is a block diagram illustrating an exemplary embodiment of the present accelerated image segmentation interfacing with a video encoder;

FIG. 8 is a block diagram illustrating an exemplary embodiment of accelerated image segmentation with a video encoder for efficient motion estimation;

FIG. 9 is a block diagram illustrating an exemplary embodiment of a video decoder;

FIG. 10 is a block diagram illustrating an exemplary embodiment of a video encoder; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In certain video encoding standards, such as HEVC, a coding tree unit (CTU) is split into coding units (CUs) by using a quaternary-tree structure denoted as coding tree to adapt to various local characteristics. The decision whether to code a picture area using inter-picture (temporal) or intra-picture (spatial) prediction is made at the leaf CU level. Each leaf CU can be further split into one, two or four prediction units (PUs) according to the PU splitting type. Inside one PU, the same prediction process can be applied and the relevant information transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One feature of the HEVC structure is that it has the multiple partition conceptions including CU, PU, and TU.

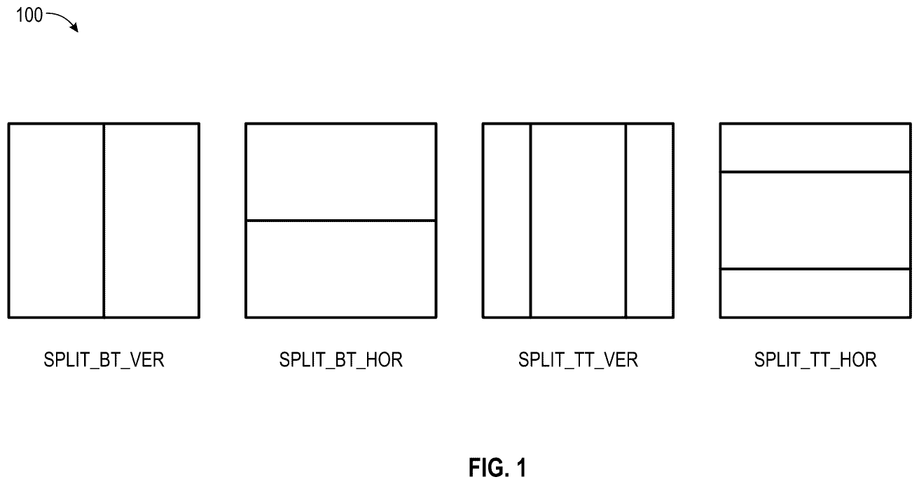

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length. This approach in VVC supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 1, there are four splitting types in multi-type tree structure, vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the color component of the CU. FIG. 1 illustrates multi-type tree splitting modes.

VVC allows a CTU to be divided into multiple CUs with a quadtree and nested multi-type tree coding block structure. The flexibility of the block partitioning adds to a large increase in encoding complexity. Determining the coding structure based on the content and avoiding evaluations of all possible partitioning will reduce encoder complexity without any significant drop in quality (or increase in bitrate).

### Image Segmentation

Image segmentation is the process of segmenting the pixels of an image into groups that belong to specific objects in an image.

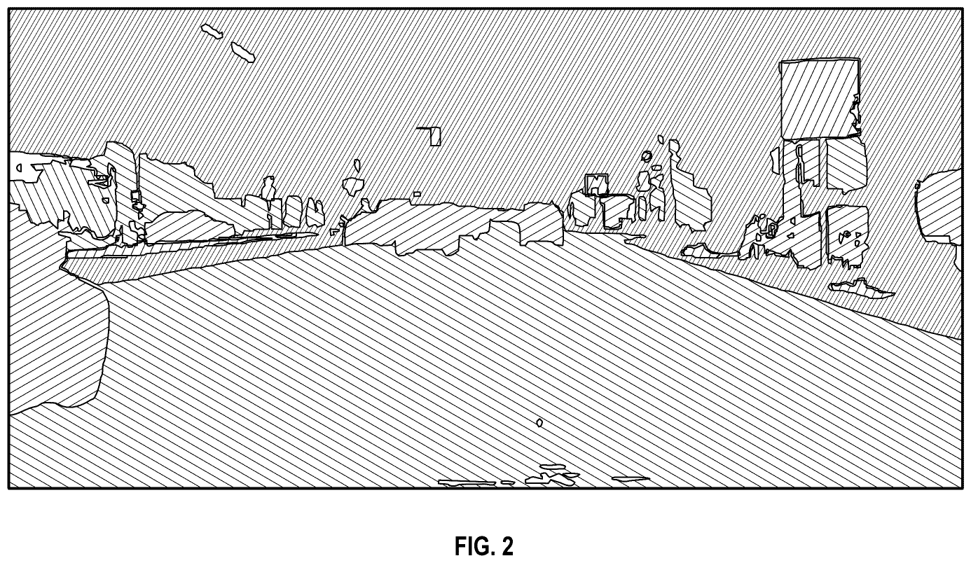

Semantic Segmentation classifies each pixel into an object class. In the example shown in FIG. 2, the segmentation mask shows objects with same semantics (cars, traffic lights, trees, people etc) with the same color. Semantic segmentation typically does not show the boundaries between two objects that are next to each other. There are applications, however, where identifying each car in a scene is necessary.

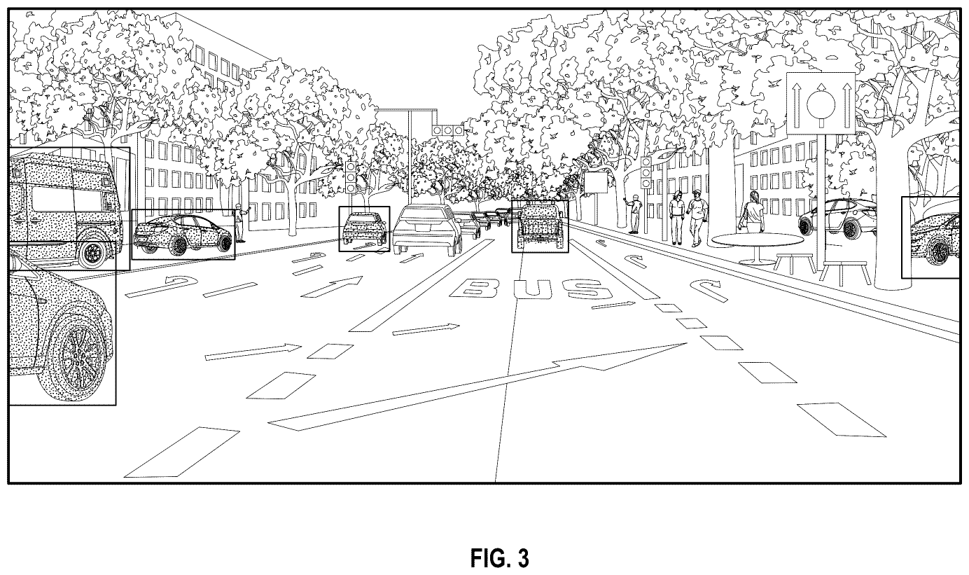

Instance Segmentation classifies pixels in an image as belonging to a specific instance of a car. This form of segmentation identifies individual objects in an image and creates masks that identify boundaries for each object instance in the image. FIG. 3 illustrates a non-limiting example of instance segmentation.

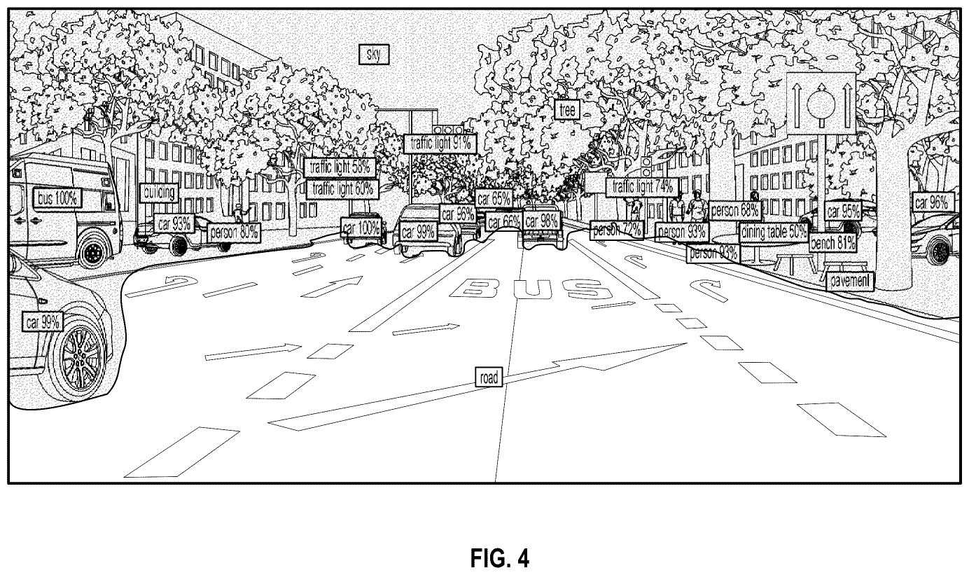

Panoptic Segmentation is a combination of semantic segmentation and instance segmentation. Panoptic segmentation classifies every pixel in an image including the background pixels. Such segmentation produces a mask that identifies each object and position of the object in the scene. FIG. 4 illustrates an exemplary embodiment of panoptic segmentation.

The segmentation algorithms can also identify each of the objects in a scene (person, car, traffic light, trees, road, bike, etc.).

Hardware Accelerated Image Segmentation: Mobile phones, PCs, and other computing hardware typically include hardware accelerators for deep neural networks (accelerated neural network inference engines). Such hardware accelerators may be integrated on system on chip (SoC) solutions or can be in the form of discrete GPU add-on boards. Such accelerators make segmentation highly efficient without using the CPU resources.

Coding Block Structure from Image Segmentation Masks: The segmentation masks obtained from the panoptic image segmentation and object recognition process can be used to determine the coding block structure used in video encoding such as VVC. In a segmentation mask, a coding block that fits entirely on the mask for a single object instance (mask with the same color) does not have to be split further. Blocks that fall on two or more object masks in an image are split to ensure each sub-block falls on a mask for one object instance. Block splitting can be thresholded to allow splitting only when the underlying mask contains no more than a certain percentage of pixels that belong to secondary masks (e.g., split block only if the largest mask is smaller than 90% of the block size). This process determines coding block partitioning in a manner that minimizes multiple objects in the same sub-block. This segmentation driven block partitioning will skip the block partitioning evaluations that are otherwise necessary in a video encoder.

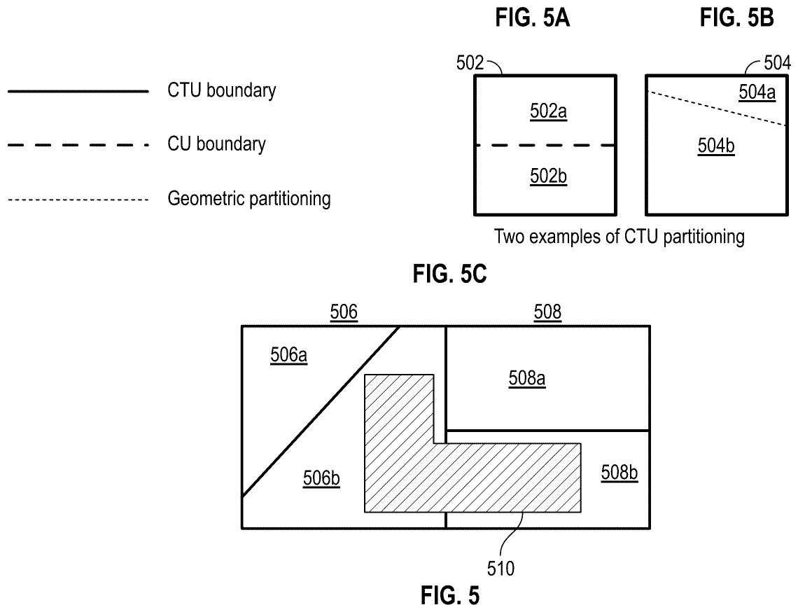

FIG. 5 illustrates examples of a CTU 502, 504 with horizontal CU partitioning (FIG. 5A) into CUs 502A and 502B and a geometric CU partitioning (FIG. 5B) with boundaries 504a and 504b, respectively. FIG. 5C illustrates two adjacent CTUs 506, 508 in which an object is identified by overlaying a segmentation mask 510 over the CTU structure. The CTUs can be partitioned based on the object boundaries. For example, in FIG. 5C, CTU 506 has a geometric partition wherein CU 506a has no object of interest and 506B includes the object of interest. Similarly, CTU 508 has a horizontal partition such that CU 508a does not include any portion of the object of interest and 508b includes the object of interest.

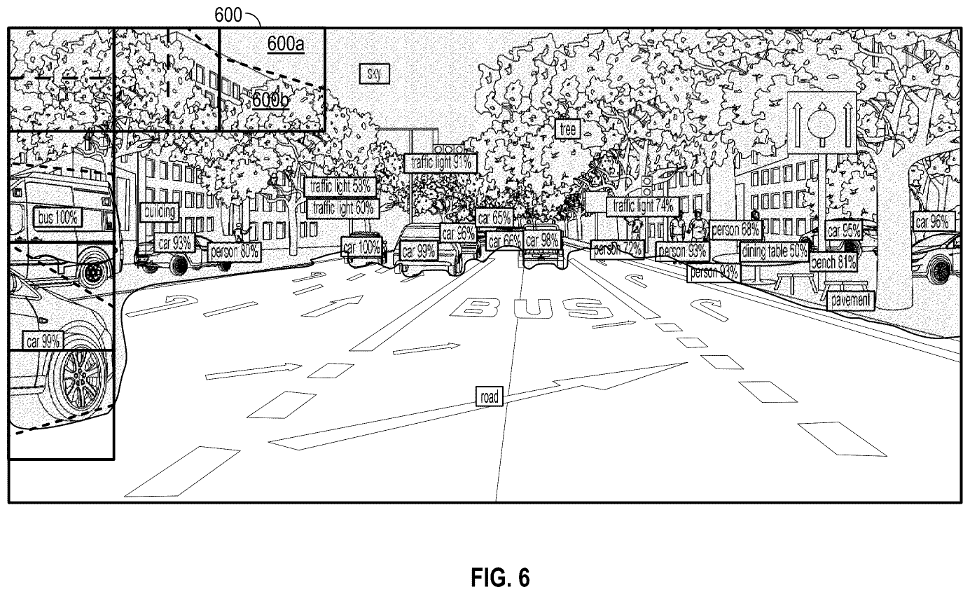

FIG. 6 illustrates the image of FIG. 4 further depicting an example of a segmentation mask to coding block structure mapping using such boundaries. FIG. 6 depicts six exemplary square CTUs. Each CTU illustrates partitioning that is determined, at least in part, based on the boundaries of the segmentation mask that identify objects within the CTU. For example, CTU 600 has a geometric partition creating CU 600a, with no object of interest and CU 600b in which the segmentation mask identifies an object of interest. Rate distortion can then be used to encode the CUs at different rates, e.g., higher resolution can be used for CU's having objects of interest, and/or different qualities, e.g., smaller quantization parameters can be used for CUs having an object of interest.

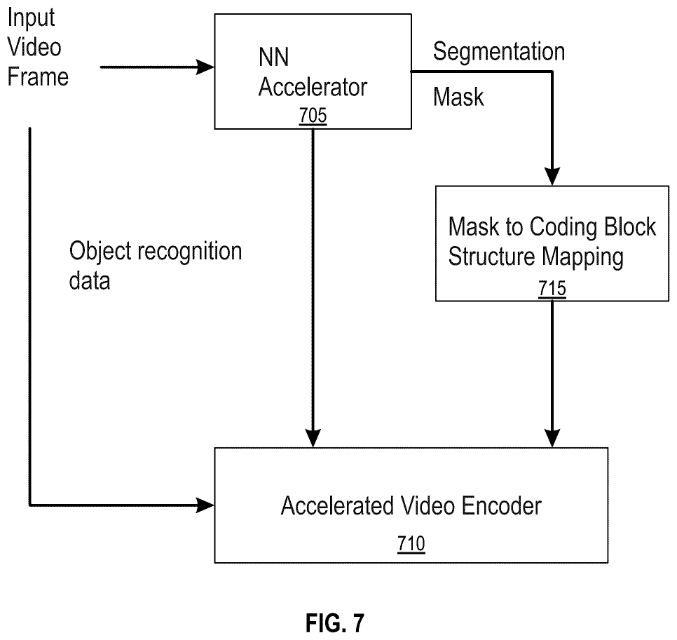

FIG. 7 illustrates a method of accelerated image segmentation interfacing with a video encoder. An input video frame is applied to both a video encoder processing element 710 and an object detection and segmentation processing stage 705, which is preferably in the form of a neural network implementing image segmentation as discussed above. The segmentation processing 705 generates object recognition data and segmentation mask(s). The object recognition data is provided to the video encoder 710 where it is used to make encoding decisions that reduce encoder complexity. The object recognition data preferably includes object instance labels for each of the pixels in a frame. The segmentation mask is provided to mask to coding block structure mapping processing 715. The segmentation mask is overlayed with the CTU structure and CTUs are partitioned based on object boundaries, as described in connection with FIG. 6. Using this information, the CTU partitioning can be simplified by picking the partitioning in which the boundaries of CUs and geometric partitioning boundaries are aligned with the edges of the objects (such as in the example given in FIG. 6). This lowers the complexity of encoding since exhaustive search of optimal partitioning is reduced to direct partitioning decision. It also can improve the quality of the encoded video in both perceptual and utility domains, since the boundaries align with the object edges and the typical artifacts introduced at the boundaries are not interfering with the object texture.

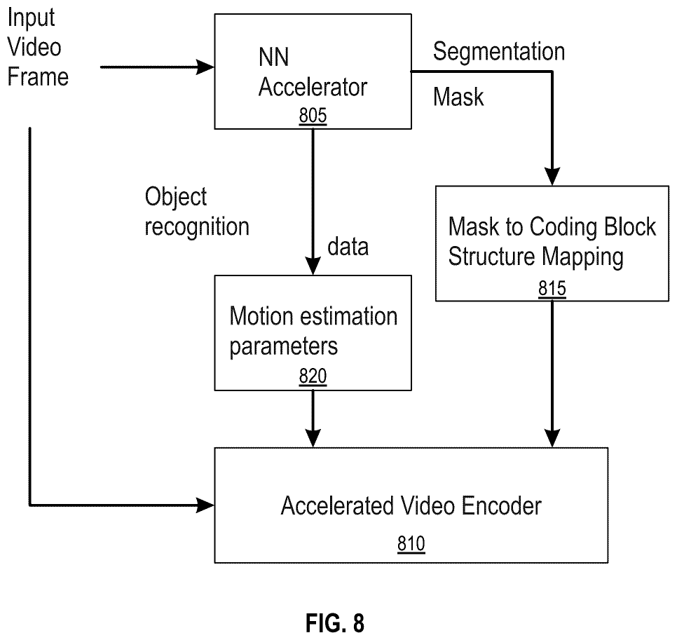

FIG. 8 illustrates accelerated image segmentation with a video encoder for efficient motion estimation. Similar to FIG. 7, the processing includes segmentation processing 805, video encoding processor 810, and a mask to coding block structure processing block 815. A motion estimation processor 820 is also provided and is interposed between the segmentation processing 805 and video encoder 81. The motion estimation processing 820 is preferably aware of the objects in the current block based on the object recognition data and can infer motion search parameters therefrom. For example, if the pixels in a block correspond to a wall or other fixed objects such as furniture, either there is no object motion or motion associated with the pixels is caused by camera motion and hence could be a candidate for using affine motion. Conversely, an object such as a car which is expected to exhibit independent motion from other objects in the scene may use a different motion transform. Moreover, the motion vectors can be calculated as a displacement of the objects using the coordinates of the detected objects, instead of using exhaustive motion estimation.

It will be appreciated that the functional blocks in FIGS. 7 and 8 can be implemented as separate hardware and software elements or integrated into a single processor operating in accordance with the specified functionality. As noted above, dedicated hardware for certain functions may be beneficial to accelerate the encoding process.

The object recognition data in FIGS. 7 and 8 generally includes information about the object class (person, face, car, bottle, tree, etc.), the position of the object in the frame, and the bounding box/size of the object. The object class can be mapped to perceptual significance to indicate how important the object is to the scene. Important objects may be encoded with better quality than less important objects detected in the frame. For example, a face may be considered more important than a tree and therefore coded with better quality (e.g., using a smaller quantization parameter in the accelerated video encoder).

The disclosed video encoder can produce a bitstream that is compliant with known video standards, such as the VVC standard and decodable with a VVC compliant decoder. The disclosed method can also be used to reduce the complexity of other encoders, such as HEVC and AV1.

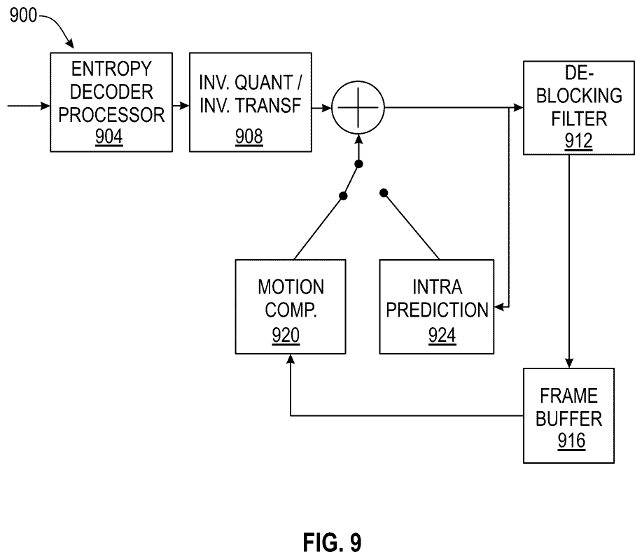

FIG. 9 is a system block diagram illustrating an example of a decoder 900 capable of practicing the present methods. Decoder 900 may include an entropy decoder processor 904, an inverse quantization and inverse transformation processor 908, a deblocking filter 912, a frame buffer 916, a motion compensation processor 920 and/or an intra prediction processor 924.

In operation, and still referring to FIG. 9, bit stream 928 may be received by decoder 900 and input to entropy decoder processor 904, which may entropy decode portions of bit stream into quantized coefficients. Quantized coefficients may be provided to inverse quantization and inverse transformation processor 908, which may perform inverse quantization and inverse transformation to create a residual signal, which may be added to an output of motion compensation processor 920 or intra prediction processor 924 according to a processing mode. An output of the motion compensation processor 920 and intra prediction processor 924 may include a block prediction based on a previously decoded block. A sum of prediction and residual may be processed by deblocking filter 912 and stored in a frame buffer 916.

In an embodiment, and still referring to FIG. 9 decoder 900 may include circuitry configured to implement any operations as described above in any embodiment as described above, in any order and with any degree of repetition. For instance, decoder 900 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

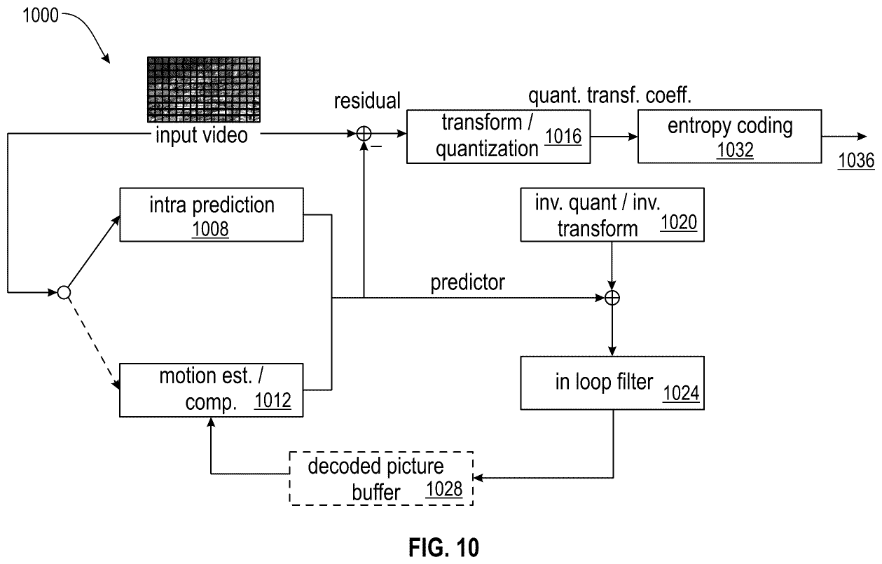

FIG. 10 is a system block diagram illustrating an example video encoder 1000 capable of adaptive cropping. Example video encoder 1000 may receive an input video 1004, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 10, example video encoder 1000 may include an intra prediction processor 1008, a motion estimation/compensation processor 1012, which may also be referred to as an inter prediction processor, capable of constructing a motion vector candidate list including adding a global motion vector candidate to the motion vector candidate list, a transform/quantization processor 1016, an inverse quantization/inverse transform processor 1020, an in-loop filter 1024, a decoded picture buffer 1028, and/or an entropy coding processor 1032. Bit stream parameters may be input to the entropy coding processor 1032 for inclusion in the output bit stream 1036.

In operation, and with continued reference to FIG. 10, for each block of a frame of input video, whether to process block via intra picture prediction or using motion estimation/compensation may be determined. Block may be provided to intra prediction processor 1008 or motion estimation/compensation processor 1012. If block is to be processed via intra prediction, intra prediction processor 1008 may perform processing to output a predictor. If block is to be processed via motion estimation/compensation, motion estimation/compensation processor 1012 may perform processing including constructing a motion vector candidate list including adding a global motion vector candidate to the motion vector candidate list, if applicable.

Further referring to FIG. 10, a residual may be formed by subtracting a predictor from input video. Residual may be received by transform/quantization processor 1016, which may perform transformation processing (e.g., discrete cosine transform (DCT)) to produce coefficients, which may be quantized. Quantized coefficients and any associated signaling information may be provided to entropy coding processor 1032 for entropy encoding and inclusion in output bit stream 1036. Entropy encoding processor 1032 may support encoding of signaling information related to encoding a current block. In addition, quantized coefficients may be provided to inverse quantization/inverse transformation processor 1020, which may reproduce pixels, which may be combined with a predictor and processed by in loop filter 1024, an output of which may be stored in decoded picture buffer 1028 for use by motion estimation/compensation processor 1012 that is capable of constructing a motion vector candidate list including adding a global motion vector candidate to the motion vector candidate list.

With continued reference to FIG. 10, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 10, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 10, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 10, encoder 1000 may include circuitry configured to implement any operations as described above in any embodiment, in any order and with any degree of repetition. For instance, encoder 1000 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 1000 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 10, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 1000 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

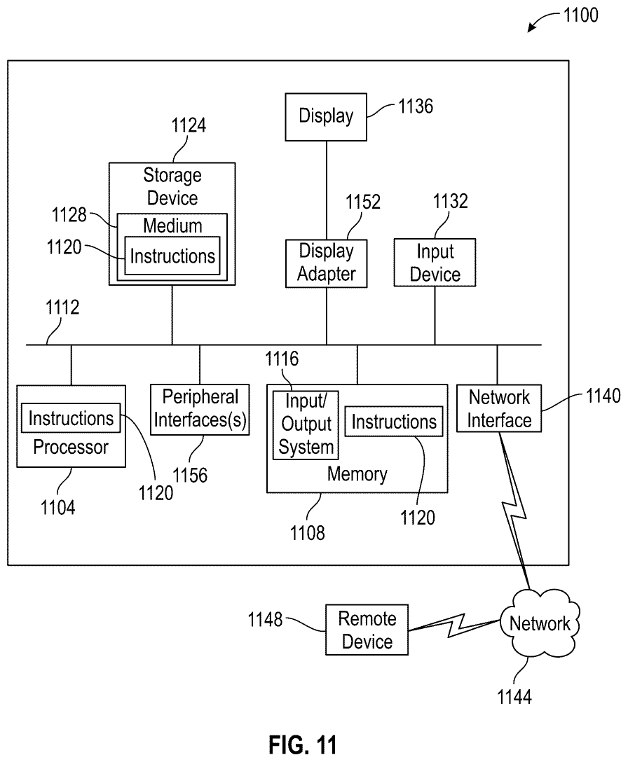

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC)

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A method of encoding a video signal comprising:
receiving a video frame comprising a plurality of pixels;
partitioning the video frame into a plurality of coding tree units (CTUs);
performing object detection and image segmentation on the video frame to generate object recognition data and at least one segmentation mask identifying object boundaries;
overlay the segmentation mask with the plurality of CTUs; and
for a CTU in which an object boundary is identified, partition the CTU into at least two coding units (CUs) in which at least one CU contains the object of interest and at least one CU does not contain an object of interest.

2. The method of claim 1, further comprising encoding a CU with at least one of a resolution or quantization parameter determined at least in part by whether the CU contains an object of interest.

3. The method of claim 1, wherein the partition is selected from the group including a horizontal partition, a vertical partition, and a geometric partition.

4. The method of claim 1, wherein the image segmentation is selected from the group including semantic segmentation, instance segmentation, and panoptic segmentation.

5. The method of claim 1, wherein the object recognition data includes instance labels for each object detected in the video frame.

6. The method of claim 1, wherein the object recognition data includes instance labels for each of the pixels in the video frame.

7. The method of claim 1, wherein the object recognition data includes object class, object position in the frame.

8. The method of claim 7, wherein the object recognition data further comprises a bounding box of an object.

9. The method of claim 2, further comprising the step of motion estimation where the motion estimation is performed at least in part based on the object recognition data.

10. A video encoder, the video encoder receiving video frame data comprising a plurality of pixels, the video frame being partitioned into a plurality of coding tree units (CTU). the encoder comprising:
an image detection and segmentation processor, the image detection and segmentation processor receiving the video frame and generating object recognition data and at least one image segmentation mask;
a mask to coding block mapping processor mapping the at least one segmentation mask to the CTUs of the video frame and partitioning at least one CTU into a plurality of coding units (CUs) based on a detected object boundary in the CTU;
a video encoding processor, the encoding processor receiving the video frame, the object recognition data and the partitioned CUs and encoding the CUs with at least one of a resolution or quantization parameter determined at least in part on whether the CU includes an object.

11. The encoder of claim 10, wherein the mask to coding block mapping processor partitions a CTU using a partition selected from the group including a horizontal partition, a vertical partition and a geometric partition.

12. The encoder of claim 10, wherein the image detection and segmentation processor applies an image segmentation method selected from the group including semantic segmentation, instance segmentation, and panoptic segmentation.

13. The encoder of claim 10, wherein the object recognition data includes instance labels for each object detected in the video frame.

14. The encoder of claim 10, wherein the object recognition data includes instance labels for each of the pixels in the video frame.

15. The encoder of claim 10, wherein the object recognition data includes object class, object position in the frame.

16. The encoder of claim 10, wherein the object recognition data further comprises a bounding box of an object.

17. The encoder of claim 10, further comprising motion estimation processing, wherein motion estimation is performed at least in part based on the object recognition data.

18. The encoder of claim 10, wherein the image detection and segmentation processor includes a neural network.
